(19) United States
(12) Patent Application Publication
(10) Pub. No.: US 2025/0286208 A1
(43) Pub. Date: Sep. 11, 2025

(54) SECONDARY BATTERY AND SECONDARY BATTERY MODULE INCLUDING THE SAME

(71) Applicant: Samsung SDI Co., Ltd., Yongin-si (KR)

(72) Inventors: Sang Won BYUN, Yongin-si (KR); Na Rae WON, Yongin-si (KR); Chan Ho LEE, Yongin-si (KR)

(21) Appl. No.: 18/778,295

(22) Filed: Jul. 19, 2024

(30) Foreign Application Priority Data
Mar. 11, 2024 (KR) 10-2024-0033611

(51) Int. Cl. H01M 50/358; H01M 50/103; H01M 50/15

(52) U.S. Cl. CPC H01M 50/358; H01M 50/103; H01M 50/15

(57) ABSTRACT

A secondary battery configured to prevent damage around a cell vent and prevent heat propagation and thermal runaway and a secondary battery module including the same. The secondary battery includes a case having a space, an electrode assembly accommodated in the space of the case, a cap assembly including a cap plate configured to seal the space of the case, the cap plate including a vent unit in one surface of the cap plate, and a terminal coupled to one side of the cap plate, the terminal being electrically connected to the electrode assembly, and an insulating member coupled to the surface of the cap plate, the insulating member being configured to cover at least a part of the vent unit.

### CROSS-REFERENCE TO THE RELATED APPLICATION

The present application claims priority to and the benefit of Korean Patent Application No. 10-2024-0033611, filed on Mar. 11, 2024, in the Korean Intellectual Property Office, the entire disclosure of which is incorporated herein by reference.

### BACKGROUND

### 1. Field

Embodiments relate to a secondary battery and a secondary battery module including the same.

### 2. Description of the Related Art

Unlike primary batteries that are not designed to be recharged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly including a positive electrode and a negative electrode, a case accommodating the positive and negative electrodes, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments provide a secondary battery configured to prevent (or at least mitigate) damage around a cell vent and to prevent (or at least mitigate) heat propagation and thermal runaway and a secondary battery module including the secondary battery.

These and other aspects and features of the present disclosure will be described in or will be apparent from the following description of embodiments of the present disclosure.

A secondary battery according to an embodiment of the present disclosure to accomplish the above object includes a case having a space defined therein, an electrode assembly accommodated in the space of the case, a cap assembly including a cap plate configured to seal the space of the case, the cap plate including a vent unit in one surface thereof, and a terminal coupled to one side of the cap plate, the terminal being electrically connected to the electrode assembly, and an insulating member coupled to the surface of the cap plate, the insulating member being configured to cover at least a part of the vent unit.

In some examples, the vent unit may be coupled to a lower surface of the cap plate, and the insulating member may be coupled to an upper surface of the cap plate and correspond to the position of the vent unit.

In some examples, the vent unit may be coupled to the cap plate and seal a vent hole formed in one side of the cap plate, and the vent unit may include a connection portion overlapping the cap plate, the connection portion being fixed to the cap plate, and a rupture portion inside the connection portion, the rupture portion having a notch.

In some examples, the insulating member may have an opening in the center region of the insulating member to expose the vent unit.

In some examples, the insulating member may include an insulating plate coupled to the upper surface of the cap plate and a protrusion protruding from the insulating plate toward the vent unit.

In some examples, a shape of the protrusion may correspond to a shape of the vent hole.

In some examples, the protrusion may have a hollow, columnar structure corresponding to the shape of the vent hole.

In some examples, the opening may extend through the insulating plate and the protrusion.

In some examples, the insulating member may be coupled along the edge of the vent hole through the protrusion.

In some examples, the cap plate may further include a seating recess in the upper surface of the cap plate around the vent hole.

In some examples, the insulating plate may be coupled to the seating recess.

In some examples, the insulating member may be coupled to the seating recess of the cap plate by an interference fit.

In some examples, the insulating member may have a ring-shaped top structure with a hollow interior.

In some examples, the insulating member may be coupled to the upper surface of the cap plate by thermal fusion.

In some examples, the insulating member and the cap plate may be integrally formed by double injection molding.

In some examples, an upper surface of the insulating member and the upper surface of the cap plate may be substantially co-planar.

In some examples, the insulating member may include at least one of polyphenylene sulfide (PPS), polyetheretherketone (PEEK), or mica.

In some examples, in response to the rupture portion being opened by the internal pressure of the case, the rupture portion may rupture along the edge of the opening of the insulating member.

In some examples, the insulating member may be configured to cover the entirety of the vent unit.

A secondary battery module according to an embodiment of the present disclosure to accomplish the above object includes secondary batteries arranged in one direction, a housing having sidewalls configured to form a receiving portion configured to accommodate the secondary batteries, and a busbar configured to electrically connect neighboring ones of the secondary batteries to each other, wherein each of the secondary batteries includes a case having a space defined therein, an electrode assembly accommodated in the space of the case, a cap assembly including a cap plate configured to seal the space of the case, the cap plate including a vent unit in one surface thereof, and a terminal coupled to one side of the cap plate, the terminal being electrically connected to the electrode assembly, and an insulating member coupled to the surface of the cap plate, the insulating member being configured to cover at least a part of the vent unit.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1A is a perspective view of a prismatic battery according to an embodiment of the present disclosure;

FIG. 1B is a cross-sectional view taken along the line 1b-1b in FIG. 1A.

FIG. 2 is a perspective view of a battery module according to an embodiment of the present disclosure;

FIGS. 3A and 3B are perspective views of a battery pack according to an embodiment of the present disclosure;

FIGS. 4A and 4B show examples of vehicle bodies and body parts to which one or more embodiments of the present disclosure may be applied;

FIGS. 5A to 5D illustrate a method for charging a secondary battery according to an embodiment of the present disclosure;

FIG. 6 is a partial exploded perspective view of a vent unit and an insulating member of a secondary battery according to an embodiment of the present disclosure;

FIG. 7A is a partial sectional view of the vent unit and the insulating member of the secondary battery according to the embodiment of the present disclosure;

FIG. 7B is a sectional view showing the vent unit of FIG. 7A when ruptured;

FIG. 8 is a partial exploded perspective view of a vent unit and an insulating member of a secondary battery according to another embodiment of the present disclosure; and

FIG. 9 is a partial sectional view of the vent unit and the insulating member of the secondary battery according to the other embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

A battery pack according to one or more embodiments includes at least one battery module and a pack housing having an accommodation space in which the at least one battery module is accommodated.

The battery module may include a plurality of battery cells and a module housing. The battery cells may be accommodated inside the module housing in a stacked form (or stacked arrangement or configuration). Each battery cell may have a positive electrode terminal and a negative electrode terminal and may be a circular type, a prismatic type, or a pouch type battery cell depending on the shape of battery. In the present specification, a battery cell may also be referred to as a secondary battery, a battery, or a cell.

In the battery pack, one cell stack may constitute one module stacked in place of the battery module. The cell stack may be accommodated in an accommodation space of the pack housing or may be accommodated in an accommodation space partitioned by a frame, a partition wall, etc. The battery cell may generate a large amount of heat during

charging/discharging. The generated heat may be accumulated in the battery cell, thereby accelerating the deterioration of the battery cell. Accordingly, the battery pack may further include a cooling member configured to remove the generated heat and thereby suppress deterioration of the battery cell. The cooling member may be at the bottom of the accommodation space where the battery cell is provided, but the present disclosure is not limited thereto and may be provided at the top or side depending on the battery pack.

The battery cell may be configured such that exhaust gas generated inside the battery cell under abnormal operating conditions, also known as thermal runaway or thermal events, is discharged to the outside of the battery cell. The battery pack or the battery module may include an exhaust port configured to discharge the exhaust gas and to thereby prevent or reduce damage to the battery pack or module by the exhaust gas.

The battery pack may include a battery and a battery management system (BMS) configured to manage the battery. The battery management system may include a detection device, a balancing device, and a control device. The battery module may include a plurality of cells connected to each other in series and/or parallel. The battery modules may be connected to each other in series and/or in parallel.

The detection device may be configured to detect a state of a battery (e.g., voltage, current, temperature, etc.) and to output state information indicating the state of the battery. The detection device may detect the voltage of each cell constituting the battery or of each battery module. The detection device may be configured to detect current flowing through each battery module constituting the battery module or the battery pack. The detection device may also be configured to detect the temperature of a cell and/or module on at least one point of the battery and/or an ambient temperature.

The balancing device may be configured to perform a balancing operation of a battery module and/or cells constituting the battery module. The control device may be configured to receive state information (e.g., voltage, current, temperature, etc.) of the battery module from the detection device. The control device may be configured to monitor and calculate the state of the battery module (e.g., voltage, current, temperature, state of charge (SOC), life span (state of health (SOH)), etc.) based on the state information received from the detection device. In addition, based on the monitored state information, the control device may be configured to perform a control function (e.g., temperature control, balancing control, charge/discharge control, etc.) and a protection function (e.g., over-discharge, over-charge, over-current protection, short circuit, fire extinguishing function, etc.). In addition, the control device may be configured to communicate (in a wired or wireless manner) with an external device of the battery pack (e.g., a higher-level controller or vehicle, charger, power conversion system, etc.).

The control device may be configured to control a charging/discharging operation and a protection operation of the battery. To this end, the control device may include a charge/discharge control unit, a balancing control unit, and/or a protection unit.

The battery management system is a system that monitors the battery state and performs diagnosis and control, communication, and protection functions, and may calculate the charge/discharge state, calculate battery life or state of health (SOH), cut off, as necessary, battery power (e.g., relay control), control thermal management (e.g., cooling, heating, etc.), perform a high-voltage interlock function, and/or may detect and/or calculate insulation and short circuit conditions.

A relay may be a mechanical contactor that is turned on and off by the magnetic force of a coil or a semiconductor switch, such as a metal oxide semiconductor field effect transistor (MOSFET).

The relay control is configured to cut off the power supply from the battery in response to a problem occurring in the vehicle and the battery system and may include one or more relays and pre-charge relays at the positive terminal and the negative terminal, respectively.

In the pre-charge control, there is a risk of inrush current occurring in the high-voltage capacitor on the input side of the inverter when the battery load is connected. Thus, to prevent inrush current when starting a vehicle, the pre-charge relay may be operated before connecting the main relay and the pre-charge resistor may be connected.

The high-voltage interlock is a circuit that uses a small signal to detect whether or not all high-voltage parts of the entire vehicle system are connected and may have a function of forcibly opening a relay in response to an opening occurring at even one location on the entire loop.

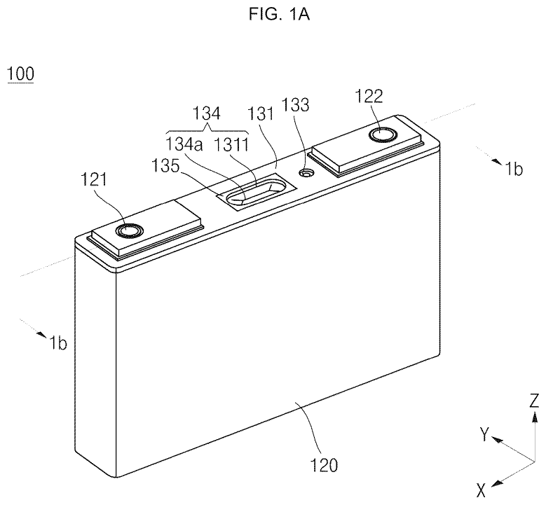

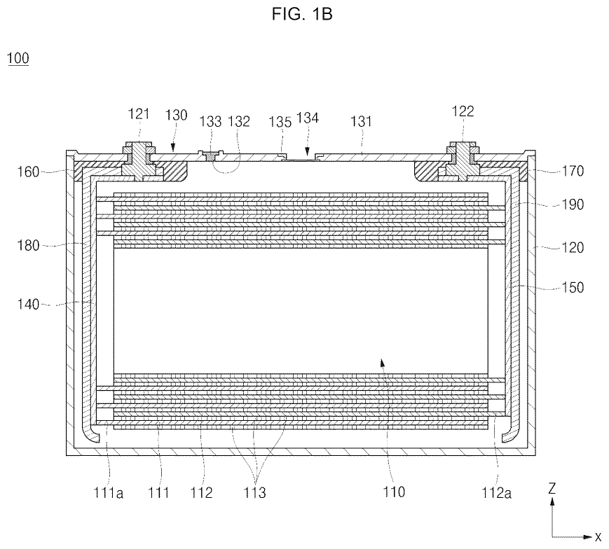

FIGS. 1A is a perspective view illustrating a secondary battery according to one or more embodiments of the present disclosure, and FIG. 1B is a cross-sectional view taken along the line 1b-1b in FIG. 1A.

Referring to FIGS. 1A and 1B, the secondary battery 100 according to one or more embodiments of the present disclosure may include at least one electrode assembly 110 wound with a separator 113 as an insulator between the positive electrode 111 and the negative electrode 112, a case 120 in which the electrode assembly 110 is received (or accommodated) therein, and a cap assembly 130 coupled to an opening of the case 120.

The secondary battery 100 according to one or more embodiments illustrated in FIGS. 1A and 1B will now be described as a prismatic lithium ion secondary battery. However, the present disclosure is not limited thereto, and suitable aspects, features and principles described herein may be applied to various other types of batteries, such as lithium polymer batteries and/or cylindrical batteries.

Each of the positive electrode 111 and the negative electrode 112 may include a current collector made of a thin metal foil having a coated portion on which an active material is coated and an uncoated portion 111a, 112a on which an active material is not coated (provided).

The positive electrode 111 and the negative electrode 112 are wound after positioning the separator 113, which is an insulator, between the positive electrode 111 and the negative electrode 112. However, the present disclosure is not limited thereto, and the electrode assembly 110 may have a structure in which a positive electrode 111 and a negative electrode 112, each made of a plurality of sheets, are alternately stacked with a separator between the positive electrode 111 and the negative electrode 112.

The case 120 may form or define the overall outer appearance of the secondary battery 100 and may be made of a conductive metal, such as aluminum, aluminum alloy, or nickel-plated steel. In addition, the case 120 may provide a space in which the electrode assembly 110 is accommodated.

The cap assembly 130 may include a cap plate 131 covering an opening in the case 120, and the case 120 and the cap plate 131 may be made of a conductive material. The positive and negative electrode terminals 121 and 122 electrically connected to the positive electrode 111 and the negative electrode 112, respectively, may penetrate (or extend through) the cap plate 131 and protrude outwardly therethrough.

In one or more embodiments, the positive and negative electrode terminals 121 and 122 protruding outwardly from the cap plate 131 may be coupled to the cap plate 131 by riveting or may be coupled to the cap plate 131 by welding. However, the present disclosure is not limited thereto, and an outer circumferential surface of an upper post of each of the positive and negative electrode terminals 121 and 122 protruding outwardly from the cap plate 131 may be threaded and may be fixed (coupled) to the cap plate 131 using a nut.

In addition, the cap plate 131 may be a thin plate and may be coupled to the opening in the case 120, and an electrolyte injection port 132 into which a sealing stopper 133 may be installed may be located (e.g., formed) in the cap plate 131, and a vent portion 134 having a notch 134a may be installed.

The positive and negative electrode terminals 121 and 122 may be electrically connected to current collectors including first and second current collectors 140 and 150 (hereinafter referred to as positive and negative current collectors) by being bonded or coupled (e.g., by welding) to the positive uncoated portion 111a and the negative electrode uncoated portion 112a, respectively.

In one or more embodiments, the positive and negative electrode terminals 121 and 122 may be coupled by welding to the positive and negative electrode current collectors 140 and 150, respectively. However, the present disclosure is not limited thereto, and the positive and negative electrode terminals 121 and 122 and the positive and negative electrode current collectors 140 and 150 may be integrally formed in one or more embodiments.

In addition, an insulation unit may be between the electrode assembly 110 and the cap plate 131. The insulation unit may include first and second lower insulation units 160 and 170, and each of the first and second lower insulation units 160 and 170 may also have a portion located between the electrode assembly 110 and the case 120.

In addition, according to one or more embodiments of the present disclosure, one end of a separation member may face one side of the electrode assembly 110 and may be installed between the insulation unit and the positive or negative electrode terminals 121 and 122.

In one or more embodiments, the separation member may include first and second separation members 180 and 190.

In one or more embodiments, first ends of the first and second separation members 180 and 190 facing one side of the electrode assembly 110 may be between a respective one of the first and second lower insulation units 160 and 170 and a respective one of the positive and negative electrode terminals 121 and 122.

Accordingly, the positive and negative electrode terminals 121 and 122, which may be coupled by welding to the positive and negative electrode current collectors 140 and 150, may be coupled to first ends of the first and second lower insulation units 160 and 170, respectively, and the first and second separation members 180 and 190, respectively.

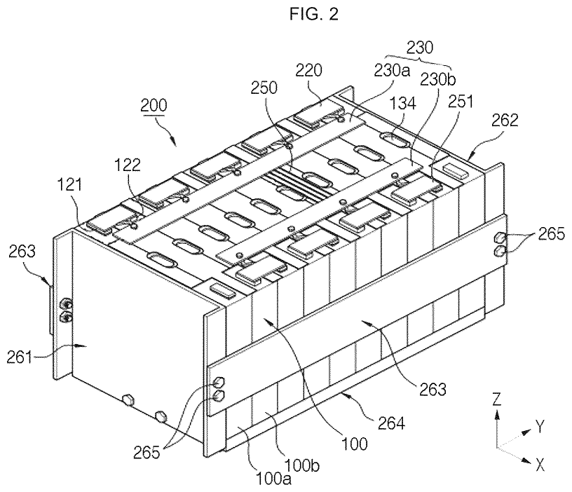

FIG. 2 is a perspective view illustrating a battery module according to one or more embodiments of the present disclosure.

Referring to FIG. 2, the battery module 200 according to one or more embodiments of the present disclosure includes electrode units 111 and 122, a plurality of battery cells 100 arranged in one direction, a plurality of connection tabs 220 each connecting a battery cell 100a to an adjacent battery cell 100b, and a protection circuit module 230 having one end connected to the connection tabs 220.

The protection circuit module 230 may include a battery management system (BMS). Further, the connection tab 220 may include a body portion in contact with the electrode units 121 and 122 between the adjacent battery cells 100a and 100b and an extension portion extending from the body portion and connected to the protection circuit module 230. The connection tab 220 may be, for example, a bus bar.

Each battery cell 100 may include a battery case, an electrode assembly received (or accommodated) in the battery case, and an electrolyte. The electrode assembly and the electrolyte react electrochemically to store and release (e.g., generate) energy. Terminal parts 121 and 122 electrically connected to the connection tab 220 and a vent 134 configured to discharge gas generated inside the battery case may be provided on one side of (e.g., an upper side of) the battery cell 100. The terminal parts 121 and 122 of the battery cell 100 may be a positive electrode terminal 121 and a negative electrode terminal 122 having different polarities from each other, and the terminal parts 121 and 122 of the adjacent battery cells 100a and 100b may be electrically connected to each other in series or parallel by the connection tab 220, to be described in more detail below. Although a serial connection has been described as an embodiment, the connection structure is not limited thereto, and various connection structures may be employed as desired or necessary. In addition, the number and arrangement of battery cells is not limited to the structure shown in FIG. 2 and may be changed as desired or necessary.

The plurality of battery cells 100 may be arranged in (e.g., may be stacked in) one direction so that the wide surfaces of the battery cells 100 face each other, and the plurality of battery cells 100 may be fixed by the housings 261, 262, 263, and 264. The housings 261, 262, 263, and 264 may include a pair of end plates 261 and 262 facing the wide surfaces of the endmost battery cells 100 and a side plate 263 and a bottom plate 264 connecting the pair of end plates 261 and 262 to each other. The side plate 263 may support side surfaces of the battery cells 100, and the bottom plate 264 may support bottom surfaces of the battery cells 100. In addition, the pair of end plates 261 and 262, the side plate 263, and the bottom plate 264 may be connected by fasteners (e.g., bolts) 265 and/or any other suitable fastening members and methods known to those of ordinary skill in the art.

The protection circuit module 230 may have electronic components and protection circuits mounted thereon and may be electrically connected to the connection tabs 220, to be described in more detail later. The protection circuit module 230 includes a first protection circuit module 230a and a second protection circuit module 230b extending along the direction in which the plurality of battery cells 100 are arranged (e.g., the Y-axis direction). The first protection circuit module 230a and the second protection circuit module 230b may be spaced from each other at a suitable interval (e.g., a predetermined interval in the X-axis direction) and arranged parallel (or substantially parallel) to each other and electrically connected to adjacent connection tabs 220. In one or more embodiments, the first protection circuit module 230a extends along one side of the upper portion of the plurality of battery cells 100 in the direction in which the plurality of battery cells 100 are arranged (e.g., the Y-axis direction), and the second protection circuit module 230b extends along the other side of the upper portion of the plurality of battery cells 100 in the direction in which the plurality of battery cells 100 are arranged (e.g., the Y-axis direction). The second protection circuit module 230b may be spaced from the first protection circuit module 230a at a suitable interval (e.g., a predetermined interval in the X-axis direction) with the vents 134 of the battery cells 100 between the first and second protection circuit modules 230a, 230b. The vents 134 may parallel (or substantially parallel) to the first and second protection circuit module 230a, 230b. As such, the two protection circuit modules are spaced from each other side-by-side along the direction in which the plurality of battery cells 100 are arranged, thereby reducing or minimizing the area of the printed circuit board (PCB) constituting the protection circuit module. By separately configuring the protection circuit module into two protection circuit modules, unnecessary PCM area can be reduced or minimized. In addition, the first protection circuit module 230a and the second protection circuit module 230b may be connected to each other by a conductive connection member 250. One side of the conductive connection member 250 is connected to the first protection circuit module 230a, and the other side thereof is connected to the second protection circuit module 230b so that the two protection circuit modules 230a and 230b can be electrically connected with each other.

The connection may be performed by any one of soldering, resistance welding, laser welding, projection welding and/or any other suitable connection methods known to those of ordinary skill in the art.

In addition, the connection member 250 may be, for example, an electric wire. In addition, the connection member 250 may be made of a material having elasticity or flexibility. Due to the connecting member 250, it may be possible to check and manage whether the voltage, temperature, and/or current of the plurality of battery cells 100 are normal. In one or more embodiments, the information received by the first protection circuit module from connection tabs adjacent to the first protection circuit module, such as voltage, current, and/or temperature, and the information received from connection tabs adjacent to the second protection circuit module, such as voltage, current, and/or temperature, may be integrated and managed by the protection circuit module through the connection member 50.

In addition, in response to the battery cell 100 swelling, shocks may be absorbed by the elasticity or flexibility of the connection member 250, thereby preventing (or at least mitigating) the first and second protection circuit modules 230a and 230b from being damaged.

In addition, the shape and structure of the connection member 250 is not limited to the shape and structure shown in FIG. 2.

As described above, because the protection circuit module 230 is provided as the first and second protection circuit modules 230a and 230b, the area of the PCB constituting the protection circuit module can be reduced or minimized, and the space inside the battery module can be secured, which improves work efficiency by facilitating a fastening work for connecting the connection tabs 220 and the protection circuit module 30 and repair work in response to an abnormality being detected in the battery module.

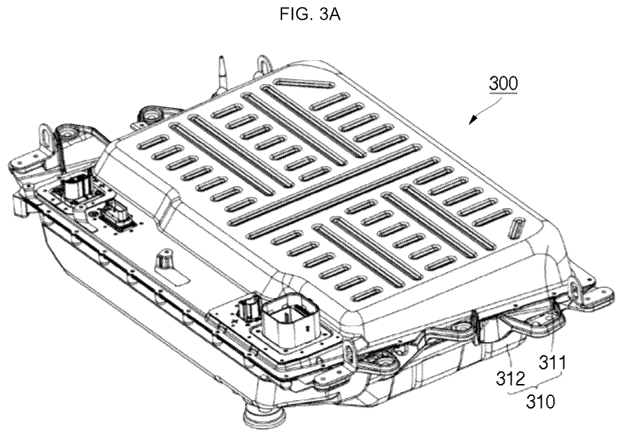

FIGS. 3A and 3B show a battery pack according to one or more embodiments of the present disclosure.

The battery pack may include a plurality of battery modules 200 and a housing 310 for accommodating the plurality of battery modules 200. In one or more embodiments, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output.

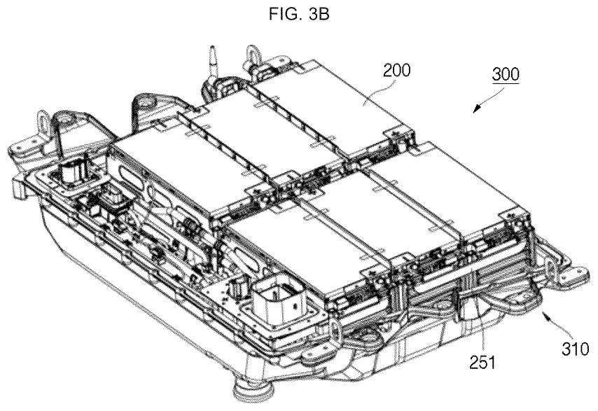

FIGS. 4A and 4B show a vehicle body and vehicle body parts having a battery pack according to one or more embodiments of the present disclosure.

In FIG. 4A, a battery pack 300 may include a battery pack cover 311, which is a part of a vehicle underbody 410, and a pack frame 312 under the vehicle underbody 410. The pack frame 312 and the battery pack cover 311 may be integral with a vehicle floor 420.

The vehicle underbody 410 separates the inside and outside of a vehicle, and the pack frame 312 may be outside the vehicle.

FIG. 4B is a schematic side view of a vehicle 500 according to one or more embodiments of the present disclosure.

A vehicle 500 may be formed by combining additional parts, such as a hood 510 in front of the vehicle and fenders 520 respectively located in the front and rear of the vehicle to a vehicle body 400.

The vehicle 500 may further include a vehicle floor 420, which is one of the vehicle body parts 400 including the battery pack 300, which includes the pack frame 312 and the battery pack cover 311.

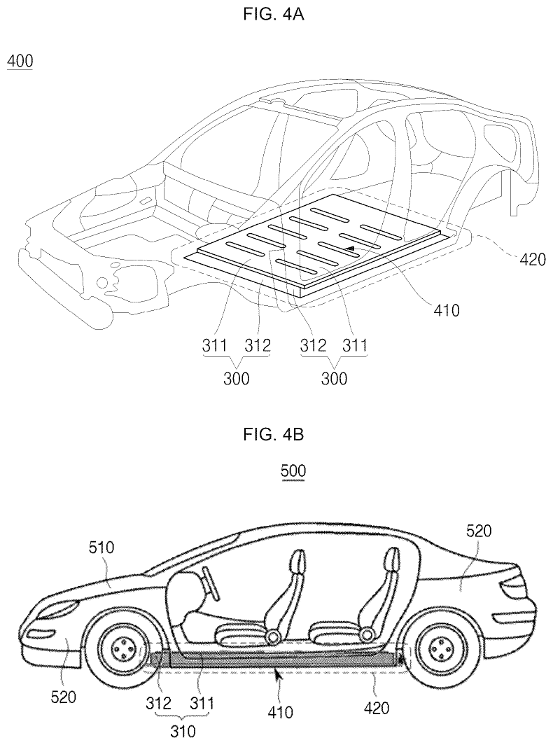

FIGS. 5A to 5D illustrate a method for charging a secondary battery according to an embodiment of the present disclosure. A secondary battery may be charged and discharged in, for example, the following manner:

### CCCV (Constant Current Constant Voltage) Charging

CCCV charging is a charging method in which constant current (CC) charging is performed until the voltage reaches a suitable or reference voltage (e.g., a predetermined voltage), and then constant voltage (CV) charging is performed until the amount of current flowing decreases until the end current value is reached.

During CC charging, as shown in FIG. 5A, a switch of a constant current power supply is turned on and a switch of a constant voltage power supply is turned off so that a constant current I flows through the secondary battery. During CC charging, because the current I is constant, a voltage VR applied to an internal resistor R is also constant according to Ohm's law (VR=R×I). Additionally, during the CC charging, a voltage VC applied to a secondary battery capacitor C increases with time. Therefore, a secondary battery voltage VB may rise over time.

In response to the secondary battery voltage VB reaching a suitable or reference voltage (e.g., a predetermined voltage), for example, about (approximately) 4.3 V, CC charging is switched to CV charging. During CV charging, as shown in FIG. 5B, the switch of the constant voltage power supply is turned on and the switch of the constant current power supply is turned off so that the secondary battery voltage VB is constant (or substantially constant). Additionally, during the CV charging, the voltage VC applied to the secondary battery capacitor C increases with time. Because VB=VR+VC is satisfied, the voltage VR applied to the internal resistor R decreases with time. As the voltage VR applied to the internal resistor R decreases, the current I flowing through the secondary battery may also decrease according to Ohm's law (VR=R×I).

In response to the current I flowing through the secondary battery reaching a suitable or reference current (e.g., a predetermined current), for example, about (approximately) 0.01 C, charging is terminated. In response to the CCCV charging finishing, all switches are turned off and the current I becomes 0 (or substantially 0), as shown in FIG. 5C. At this time, the voltage VR applied to the internal resistor R becomes 0 V (or substantially 0 V). Accordingly, even when voltage drop is prevented across the internal resistor R, the secondary battery voltage VB does not decrease (or at least substantially does not decrease).

FIG. 5D shows a graph of a secondary battery voltage VB and charging current during CCCV charging and after CCCV charging is terminated. Even after CCCV charging is terminated, the secondary battery voltage VB does not decrease (or at least substantially does not decrease).

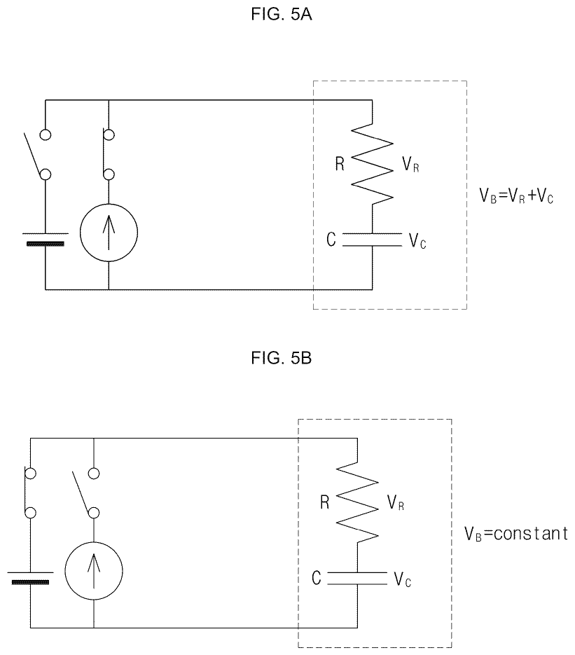

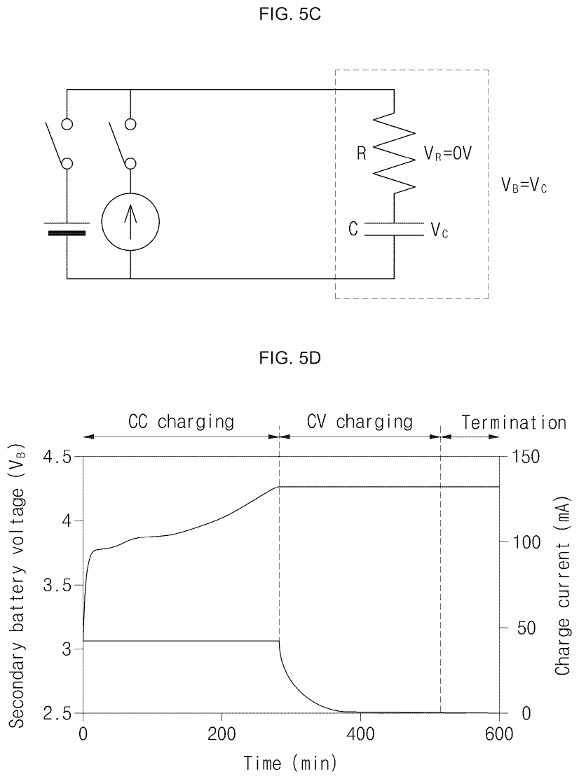

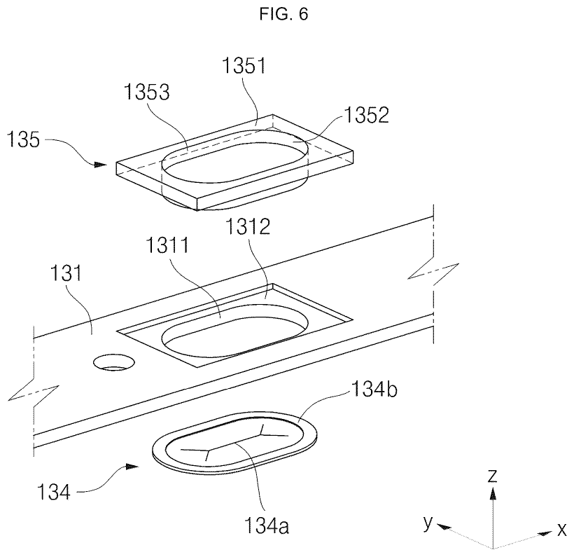

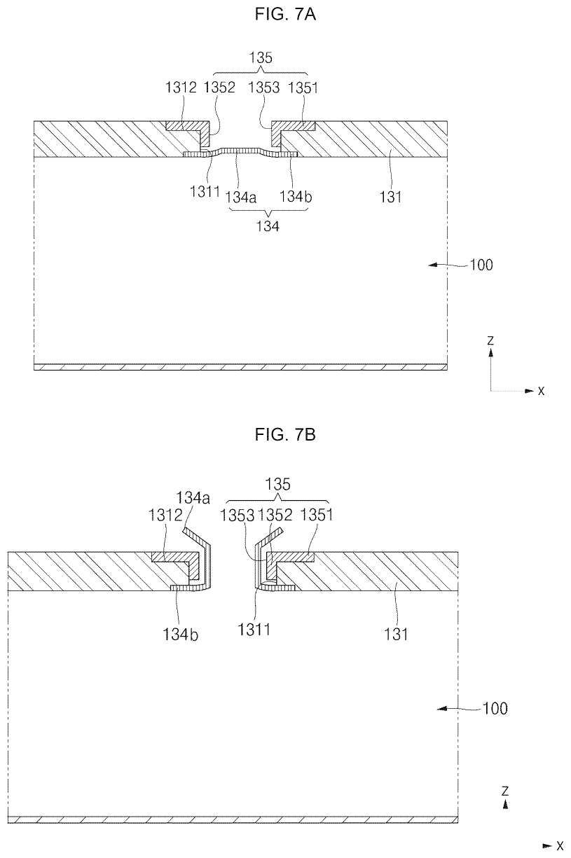

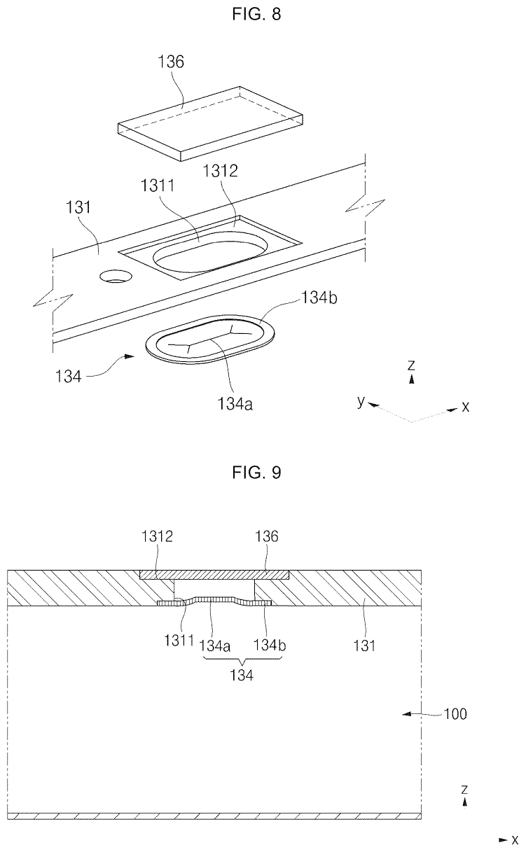

FIG. 6 is a partial exploded perspective view of a vent unit 134 and an insulating member 135 of a secondary battery 100 according to an embodiment of the present disclosure. FIG. 7A is a partial sectional view of the vent unit 134 and the insulating member 135 of the secondary battery 100 according to the embodiment of the present disclosure. FIG. 7B is a partial sectional view showing the vent unit 134 of FIG. 7A in a ruptured state. FIG. 8 is a partial exploded perspective view of a vent unit 134 and an insulating member 136 of a secondary battery 100 according to another embodiment of the present disclosure. FIG. 9 is a partial sectional view of the vent unit 134 and the insulating member 136 of the secondary battery 100 according to the other embodiment of the present disclosure. Herein, “battery cell” and “secondary battery” may be used interchangeably.

Referring to FIGS. 1A, 1B, 2, and 6, the secondary battery 100 may include a case 120 having a space defined therein, an electrode assembly 110 accommodated in the space of the case 120, a cap assembly 130, and an insulating member 135 at the cap assembly 130. In one or more embodiments, the cap assembly 130 may include a cap plate 131 configured to seal the space of the case 120, the cap plate 131 including a vent unit 134 in one surface, and terminals 121 and 122 coupled to one side of the cap plate 131 and electrically connected to the electrode assembly 110.

In one or more embodiments, the insulating member 135 may be located so as to correspond to the vent unit 134 and may be configured to cover at least a part (or portion) of the vent unit 134. In one or more embodiments, the insulating member 135 may be at an upper side of the vent unit 134 and cover the edge of the vent unit 134, thereby preventing (or at least mitigating) damage around the vent unit 134 during heat propagation.

In one or more embodiments, the cap plate 131 may include a vent hole 1311 through which the vent unit 134 and the insulating member 135 are coupled to each other, and a seating recess 1312 to which the insulating member 135 is coupled. The seating recess 1312 may be in an upper surface of the cap plate 131 and extend around the vent hole 1311.

In one or more embodiments, the vent unit 134 may be coupled or connected to the cap plate 131 and seal the vent hole 1311 in one side of the cap plate 131. The shape of the vent hole 1311 and the shape of the vent unit 134 may correspond to each other (e.g., the vent hole 1311 and the vent unit 134 may have the same shape). As used herein, “corresponding” means that two parts are similar or identical to each other. In one or more embodiments, both the vent hole 1311 and the vent unit 134 may be oval. In one or more embodiments, the vent unit 134 may include a connection portion 134b overlapping the cap plate 131 and fixed to the cap plate 131 and a rupture portion 134a inside the connection portion 134b that includes a notch. In one or more embodiments, the connection portion 134b may be the edge portion of the vent unit 134. The connection portion 134b may be coupled to a lower end of the vent hole 1311.

In one or more embodiments, the insulating member 135 may have an opening 1353 in the center region (or substantially the center region) to expose the vent unit 134. In response to the vent unit 134 being ruptured, at least a part of the vent unit 134 may protrude outwardly through the opening 1353. In one or more embodiments, the insulating member 135 may include an insulating plate 1351 coupled to the upper surface of the cap plate 131 and a protrusion 1352 protruding (e.g., downward) from the insulating plate 1351 toward the vent unit 134. In one or more embodiments, the insulating plate 1351 may be coupled to the seating recess 1312 of the cap plate 131. The protrusion 1352 may be coupled to the vent hole 1311 of the cap plate 131. The protrusion 1352 may correspond to the shape of the vent hole 1311. In one or more embodiments, the opening 1353 may extend through the insulating plate 1351 and the protrusion 1352. In one or more embodiments, the protrusion 1352 may have a hollow, columnar structure corresponding to the shape of the vent hole 1311. The insulating plate 1351 may have a flat structure with a hollow center region corresponding to the shape of the vent hole 1311. However, the present disclosure is not limited thereto, and the insulating member 135 may have a ring-shaped top structure with a hollow interior. In one or more embodiments, the insulating plate 1351 may not have a plate shape.

In one or more embodiments, referring to FIG. 7A, a vent unit 134 may be at (e.g., on) a lower surface of the cap plate 131, and the insulating member 135 may be coupled to the upper surface of the cap plate 131 at a position corresponding to the position of the vent unit 134. The insulating member 135 may be coupled along the edge of the vent hole 1311 through the protrusion 1352.

In one or more embodiments, the insulating member 135 may be coupled to the seating recess 1312 of the cap plate 131 with an interference fit. In one or more embodiments, the insulating member 135 may be coupled to the upper surface of the cap plate 131 by thermal fusion. The insulating member 135 and the cap plate 131 may be integrally formed by double injection molding. In one or more embodiments, the upper surface of the insulating member 135 and the upper surface of the cap plate 131 may be on the same plane (or substantially the same plane) (e.g., the upper surface of the insulating member 135 and the upper surface of the cap plate 131 may be co-planar or substantially co-planar). In one or more embodiments, the insulating member 135 may include at least one of polyphenylene sulfide (PPS), polyetheretherketone (PEEK), and/or mica. In one or more embodiments, the insulating member 135 may further include a high heat resistant resin such as polyphthalamide (PPA), thermoplastic polyimide (TPI), polysulfone (PSU), polyethersulfone (PES), polyetherimide, and/or liquid crystal polymer (LCP). In one or more embodiments, mica may be provided in a sheet form. In one or more embodiments, the mica sheet may include a rigid mica sheet (e.g., phlogopite or muscovite), a composite mica sheet (e.g., glass fiber reinforced mica sheet), flexible mica (e.g., rolled mica), or a molded mica sheet.

Referring to FIG. 7B, in some embodiments, in response to the internal pressure of the case 120 being greater than a preset threshold pressure and the rupture portion 134a being opened (i.e., an event occurs), the rupture portion 134a may rupture toward the edge of the opening 1353 of the insulating member 135. Consequently, the insulating member 135 may be fixed by the deformed vent unit 134.

In one or more embodiments, damage around the vent of the battery cell where the event occurred may be prevented (or at least mitigated), and heat propagation may be remedied by reducing thermal effects through the cap plate around the vent of the battery cell.

Referring to FIGS. 8 and 9, the insulating member 136 may be configured to cover the entirety (or substantially the entirety) of the vent unit 134. The insulating member 136 may have a flat (planar) shape so as to be coupled to the seating recess 1312, rather than having the structure of the protrusion 1352 formed separately. Consequently, a gap may be provided between the insulating member 136 and the vent unit 134. In some embodiments, the upper surface of the insulating member 136 and the upper surface of the cap plate 131 may be on the same or substantially the same plane (i.e., co-planar or substantially co-planar). Configurations other than the structure of the insulating member 136 are identical to those described above, and therefore a description thereof will be omitted.

As is apparent from the above description, embodiments provide a secondary battery capable of preventing (or at least mitigating) damage around a cell vent and a secondary battery module including the same.

Embodiments provide a secondary battery capable of preventing (or at least mitigating) heat propagation and thermal runaway and a secondary battery module including the same.

Although the present disclosure has been described by limited embodiments and drawings, the present disclosure is not limited thereto. However, various modifications and variations can be made by a person skilled in the art to which the present disclosure belongs within the scope of equivalency of the technical idea of the present disclosure and the scope of the present invention as set forth in the following claims.

What is claimed is:

1. A secondary battery comprising:
a case comprising a space;
an electrode assembly accommodated in the space of the case;
a cap assembly comprising a cap plate configured to seal the space of the case, the cap plate comprising a vent unit in one surface of the cap plate, and a terminal coupled to one side of the cap plate, the terminal being electrically connected to the electrode assembly; and
an insulating member coupled to the surface of the cap plate, the insulating member being configured to cover at least a part of the vent unit.

2. The secondary battery as claimed in claim 1, wherein:
the vent unit is coupled to a lower surface of the cap plate, and
the insulating member is coupled to an upper surface of the cap plate corresponding to a position of the vent unit.

3. The secondary battery as claimed in claim 1, wherein:
the vent unit is coupled to the cap plate, the vent unit sealing a vent hole in one side of the cap plate, and
the vent unit comprises a connection portion overlapping the cap plate, the connection portion being fixed to the cap plate, and a rupture portion inside the connection portion, the rupture portion comprising a notch.

4. The secondary battery as claimed in claim 3, wherein the insulating member comprises an opening in a center region of the insulating member, the opening being configured to expose the vent unit.

5. The secondary battery as claimed in claim 4, wherein the insulating member comprises an insulating plate coupled to an upper surface of the cap plate and a protrusion protruding from the insulating plate toward the vent unit.

6. The secondary battery as claimed in claim 5, wherein the protrusion corresponds to a shape of the vent hole.

7. The secondary battery as claimed in claim 5, wherein the protrusion comprises a hollow, columnar structure corresponding to a shape of the vent hole.

8. The secondary battery as claimed in claim 5, wherein the opening extends through the insulating plate and the protrusion.

9. The secondary battery as claimed in claim 5, wherein the insulating member is coupled along an edge of the vent hole through the protrusion.

10. The secondary battery as claimed in claim 5, wherein the cap plate further comprises a seating recess in the upper surface of the cap plate around the vent hole.

11. The secondary battery as claimed in claim 10, wherein the insulating plate is coupled to the seating recess.

12. The secondary battery as claimed in claim 11, wherein the insulating member is coupled to the seating recess of the cap plate by an interference fit.

13. The secondary battery as claimed in claim 1, wherein the insulating member comprises a ring-shaped top structure with a hollow interior.

14. The secondary battery as claimed in claim 1, wherein the insulating member is thermally fused to an upper surface of the cap plate.

15. The secondary battery as claimed in claim 1, wherein the insulating member and the cap plate are integral by double injection molding.

16. The secondary battery as claimed in claim 1, wherein an upper surface of the insulating member and an upper surface of the cap plate are co-planar.

17. The secondary battery as claimed in claim 1, wherein the insulating member comprises at least one of polyphenylene sulfide (PPS), polyetheretherketone (PEEK), or mica.

18. The secondary battery as claimed in claim 4, wherein the rupture portion is configured to rupture along an edge of the opening of the insulating member in response to an internal pressure of the case.

19. The secondary battery as claimed in claim 1, wherein the insulating member is configured to cover substantially an entirety of the vent unit.

20. A secondary battery module comprising:
a plurality of secondary batteries arranged in one direction;
a housing comprising sidewalls forming a receiving portion configured to accommodate the plurality of secondary batteries; and
a busbar configured to electrically connect neighboring ones of the plurality of secondary batteries to each other, wherein
each of the plurality of secondary batteries comprises:
a case comprising a space;
an electrode assembly accommodated in the space;
a cap assembly comprising a cap plate configured to seal the space of the case, the cap plate comprising a vent unit in one surface of the cap plate, and a terminal coupled to one side of the cap plate, the terminal being electrically connected to the electrode assembly; and
an insulating member coupled to the surface of the cap plate, the insulating member being configured to cover at least a part of the vent unit.
